(19) United States
(12) Patent Application Publication
(10) Pub. No.: US 2023/0287252 A1
(43) Pub. Date: Sep. 14, 2023

(54) HEAT MEDIUM

(71) Applicant: SEBATA SHUDAN CO., LTD., Ibaraki (JP)

(72) Inventor: Keiichi SEBATA, Ibaraki (JP)

(73) Assignee: SEBATA SHUDAN CO., LTD., Ibaraki (JP)

(21) Appl. No.: 18/013,550

(22) PCT Filed: Jun. 30, 2020
(86) PCT No.: PCT/JP2020/025674

§ 371 Date: Dec. 29, 2022

(51) Int. Cl. C09K 5/04

(52) U.S. Cl. CPC C09K 5/041; C09K 2205/106; C09K 2205/12; C09K 2205/132

(57) ABSTRACT

A heat medium contains liquefied isobutane, liquefied carbon dioxide, and liquid nitrogen. The content of liquefied isobutane is 20 to 30% by mass of the total amount of the heat medium, the content of liquefied carbon dioxide is 50 to 70% by mass of the total amount of the heat medium, and the content of liquid nitrogen is 10 to 20% by mass of the total amount of the heat medium. Even if containing flammable liquefied isobutane, the heat medium is non-flammable because it is mixed with non-flammable liquefied carbon dioxide. The heat medium does not contain chlorine or fluorine, so that it has a low environmental load.

### BACKGROUND

### Field of the Invention

The present invention relates to a heat medium. More specifically, the present invention relates to a heat medium used in an air conditioner, for example.

### Background Art

The refrigerant is a heat medium used for transferring heat, and circulates in a pipe connecting an indoor unit and an outdoor unit when used in an air conditioner.

That is, the refrigerant circulates in the pipe while carrying heat in the air and conveys the heat to a heat exchanger. The heat transfer by the refrigerant realizes cooling and heating.

Chlorofluorocarbons (CFCs) have been developed as refrigerants to replace ammonia and CFCs have been widespread.

CFCs are compounds in which some or all of hydrogen of hydrocarbon such as methane and ethane are substituted with halogen such as fluorine and chlorine.

However, CFCs contain chlorine and are stable in material terms, so that they rise to the stratosphere and cause a problem of destroying the ozone layer.

Therefore, hydrochlorofluorocarbons (HCFCs) having an ozone depletion potential smaller than that of CFCs have come to be used. Hydrochlorofluorocarbons are chlorofluorocarbons containing hydrogen.

Here, the “ozone depletion potential” is a value expressing a destructive effect that is given to the ozone layer by a substance per unit weight released into the atmosphere as a relative value with trichlorofluoromethane (CFC-11) as a reference value (=1).

Various refrigerants have been proposed. For example, Patent Literature 1 describes a refrigerant containing chlorodifluoromethane (hereinafter, referred to as “R-22”) and 1-chloro-1,1-difluoroethane (hereinafter, referred to as “R-142b”), which are kinds of HCFCs, and further octafluoropropane (hereinafter, referred to as “R-218”) as a refrigerant having no risk of destroying the ozone layer.

### Citation List

### [Patent Documents]

Patent Document 1: Japanese Unexamined Patent Application Publication No. 2001-19945

### SUMMARY OF THE INVENTION

### Technical Problems

However, R-22, R-142b, and R-218 have been found to have a large global warming potential although the ozone depletion potential is small, leading to a problem from the viewpoint of prevention of global warming.

More specifically, the global warming potential of R-22 is 1,810, the global warming potential of R-142b is 2,310, and the global warming potential of R-218 is 8,830.

Here, the “global warming potential” is a value expressing the 100-year strength of the greenhouse effect per unit concentration in the atmosphere of the substance as a relative value when carbon dioxide is defined as a reference value (=1).

Under these circumstances, there is a movement in which a substance that is not artificially chemically synthesized such as CFCs but originally exists in nature and has established a circulation cycle from generation to extinction is actively used as a refrigerant from the standpoint of the global environmental protection such as ozone layer protection and prevention of global warming, and such a refrigerant is called a “natural refrigerant.”

Substances that can be used as such natural refrigerants include hydrocarbons such as propane and butane, ammonia, carbon dioxide, air, and water.

Here, ammonia, propane, etc., have a global warming potential of “0” in addition to the ozone depletion potential being “0” and are great substances for the global environment. However, it is perceived as a problem that they are flammable.

Hence, a heat medium has been required that exhibits sufficient heat transfer performance, has both low ozone depletion potential and global warming potential, that is, has a low environmental load, and is non-flammable.

The present invention has been made in view of the above point, and an object thereof is to provide a heat medium that exhibits sufficient heat transfer performance, has a low environmental load, and is non-flammable.

### Solution to Problems

In order to achieve the foregoing object, a heat medium of the present invention contains liquefied isobutane and liquefied carbon dioxide.

Here, liquefied isobutane, which is flammable, is mixed with non-flammable liquefied carbon dioxide, so that the resulting heat medium of the present invention can be non-flammable even though it contains isobutane.

Further, the heat medium of the present invention can exhibit high cooling capacity due to the liquefied carbon dioxide.

Further, the heat medium of the present invention does not contain chlorine or fluorine, so that the ozone depletion potential of the heat medium of the present invention is “0” and the global warming potential is “1 or less.”

Further, the heat medium of the present invention can be configured to further contain liquid nitrogen.

In this case, liquefied isobutane, which is flammable, is further mixed with non-flammable liquid nitrogen, so that the non-flammability of the resulting heat medium of the present invention is further enhanced.

Further, the heat medium of the present invention can exhibit even higher cooling capacity due to liquid nitrogen.

Further, in the heat medium of the present invention further containing liquified nitrogen, the liquefied isobutane may have a content of 20 to 30% by mass of a total amount of the heat medium, the liquefied carbon dioxide may have a content of 50 to 70% by mass of the total amount of the heat medium, and the liquid nitrogen may have a content of 10 to 20% by mass of the total amount of the heat medium.

In particular, in the heat medium of the present invention further containing liquid nitrogen, the liquefied isobutane may have a content of 20% by mass of a total amount of the heat medium, the liquefied carbon dioxide may have a content of 70% by mass of the total amount of the heat medium, and the liquid nitrogen may have a content of 10% by mass of the total amount of the heat medium.

In this case, the content of liquefied isobutane is 20 to 30% by mass of the total amount of the heat medium, which makes it easier to maintain an appropriate pressure value of the heat medium in the air conditioner and makes it easier to maintain appropriate heat transfer performance.

Further, the content of liquefied carbon dioxide is 50 to 70% by mass of the total amount of the heat medium, which makes it easier to maintain high cooling capacity while maintaining an appropriate pressure value of the heat medium in the air conditioner.

Further, the content of liquid nitrogen is 10 to 20% by mass of the total amount of the heat medium, which makes it easier to maintain high cooling capacity while maintaining an appropriate pressure value of the heat medium in the air conditioner.

Furthermore, the heat medium of the present invention can be configured to further contain benzotriazole.

In this case, copper-containing refrigerant piping of the air conditioner, with which the heat medium of the present invention is in contact, can be prevented from rusting.

Further, in the heat medium of the present invention further containing liquid nitrogen and benzotriazole, the liquefied isobutane may have a content of 20 to 30% by mass of a total amount of the heat medium, the liquefied carbon dioxide may have a content of 30 to 50% by mass of the total amount of the heat medium, the liquid nitrogen may have a content of 15 to 25% by mass of the total amount of the heat medium, and the benzotriazole may have a content of 1 to 10% by mass of the total amount of the heat medium.

In particular, in the heat medium of the present invention further containing liquid nitrogen and benzotriazole, the liquefied isobutane may have a content of 29% by mass of a total amount of the heat medium, the liquefied carbon dioxide may have a content of 49% by mass of the total amount of the heat medium, the liquid nitrogen may have a content of 19% by mass of the total amount of the heat medium, and the benzotriazole may have a content of 3% by mass of the total amount of the heat medium.

In this case, the content of liquefied isobutane is 20 to 30% by mass of the total amount of the heat medium, which makes it easier to maintain an appropriate pressure value of the heat medium in the air conditioner while exhibiting the effect of rust prevention of the copper-containing refrigerant piping of the air conditioner and makes it easier to maintain appropriate heat transfer performance.

Further, the content of liquefied carbon dioxide is 30 to 50% by mass of the total amount of the heat medium, which makes it easier to maintain high cooling capacity while maintaining an appropriate pressure value of the heat medium in the air conditioner while exhibiting the effect of rust prevention of the copper-containing refrigerant piping of the air conditioner.

Further, the content of liquid nitrogen is 15 to 25% by mass of the total amount of the heat medium, which makes it easier to maintain high cooling capacity while maintaining an appropriate pressure value of the heat medium in the air conditioner while exhibiting the effect of rust prevention of the copper-containing refrigerant piping of the air conditioner.

Further, the content of benzotriazole is 1 to 10% by mass of the total amount of the heat medium, which makes it easier to exhibit the effect of rust prevention of the copper-containing refrigerant piping of the air conditioner without affecting the heat transfer performance and the cooling capacity.

### Advantageous Effects of Invention

The heat medium according to the present invention exhibits sufficient heat transfer performance, has a low environmental load, and is non-flammable.

### BRIEF DESCRIPTION OF THE DRAWINGS

(a) of FIG. 1 is a schematic diagram showing a flow of a refrigerant to which the present invention was applied in an air conditioner during a heating operation and (b) of FIG. 1 is a schematic diagram showing a flow of the refrigerant to which the present invention was applied in the air conditioner during a cooling operation.

(a) of FIG. 2 is a graph showing changes over time for various temperatures for the first time when the cooling operation of the air conditioner was performed using the refrigerant to which the present invention was applied, and (b) of FIG. 2 is a graph showing changes over time for various temperatures for the second time when the cooling operation of the air conditioner was performed using the refrigerant to which the present invention was applied.

FIG. 3 is a graph showing changes over time for various temperatures when the cooling operation of the air conditioner was performed using a conventional refrigerant R-22.

FIG. 4 is a graph showing changes over time for various temperatures when the cooling operation of the air conditioner was performed using a conventional refrigerant HY-99.

FIG. 5 is a graph showing changes over time for various temperatures when the heating operation of the air conditioner was performed using the refrigerant to which the present invention was applied.

FIG. 6 is a graph showing changes over time for various temperatures when the heating operation of the air conditioner was performed using the conventional refrigerant R-22.

FIG. 7 is a graph showing changes over time for various temperatures when the heating operation of the air conditioner was performed using the conventional refrigerant HY-99.

### DESCRIPTION OF THE EMBODIMENTS

A heat medium of the present invention contains liquefied isobutane and liquefied carbon dioxide.

Further, the heat medium of the present invention can further contain liquid nitrogen and benzotriazole.

Further, the heat medium of the present invention is manufactured by mixing isobutane in a liquid state and carbon dioxide in a liquid state, and the heat medium of the present invention containing liquid nitrogen is manufactured by mixing isobutane in a liquid state, carbon dioxide in a liquid state, and nitrogen in a liquid state.

Further, the heat medium of the present invention containing benzotriazole is manufactured by adding benzotriazole.

In the heat medium of the present invention further containing liquid nitrogen, the content of liquefied isobutane is preferably 20 to 30% by mass of the total amount of the heat medium.

Further, in the heat medium of the present invention further containing liquid nitrogen, the content of liquefied carbon dioxide is preferably 50 to 70% by mass of the total amount of the heat medium.

Further, in the heat medium of the present invention further containing liquid nitrogen, the content of liquid nitrogen is preferably 10 to 20% by mass of the total amount of the heat medium.

Further, in the heat medium of the present invention further containing benzotriazole in addition to liquid nitrogen, the content of liquefied isobutane is preferably 20 to 30% by mass of the total amount of the heat medium.

Further, in the heat medium of the present invention further containing benzotriazole in addition to liquid nitrogen, the content of liquefied carbon dioxide is preferably 30 to 50% by mass of the total amount of the heat medium.

Further, in the heat medium of the present invention further containing benzotriazole in addition to liquid nitrogen, the content of liquid nitrogen is preferably 15 to 25% by mass of the total amount of the heat medium.

Further, in the heat medium of the present invention further containing benzotriazole in addition to liquid nitrogen, the content of benzotriazole is preferably 1 to 10% by mass of the total amount of the heat medium.

Further, the heat medium of the present invention is used in a device similar to a device in which a general heat medium is used, and is used in, for example, an air conditioner, a refrigerator, or heat pump.

Here, flows of the heat medium of the present invention when the heat medium of the present invention is used in an air conditioner will be described with reference to the drawings.

(a) of FIG. 1 is a schematic diagram showing a flow of the refrigerant to which the present invention was applied in the air conditioner during a heating operation and (b) of FIG. 1 is a schematic diagram showing a flow of the refrigerant to which the present invention was applied in the air conditioner during a cooling operation.

As shown in FIG. 1, an air conditioner 1 includes an outdoor unit 11 installed outdoors, an indoor unit 12 installed indoors, and piping (101, 102) communicating the outdoor unit 11 and the indoor unit 12.

Further, the outdoor unit 11 has a compressor 111.

Here, the compressor 111 applies pressure to the heat medium of the present invention and brings the heat medium of the present invention in a liquid state to a high-temperature gaseous state.

Further, the outdoor unit 11 has an outdoor heat exchanger 112.

Further, the outdoor heat exchanger 112 has a fan 115.

Here, the outdoor heat exchanger 112 forms a flow of fluid in a fixed direction by the fan 115. More specifically, the outdoor heat exchanger 112 takes outdoor air into the outdoor heat exchanger 112 by the fan 115, transfers heat between the taken outdoor air and the heat medium of the present invention, and then releases the air to the outdoors as cold air CA or warm air WA by the fan 115.

When the air conditioner 1 is in the heating operation, the outdoor heat exchanger 112 causes the low-temperature, low-pressure, and liquid-state heat medium of the present invention to absorb the heat of the outdoor air, and releases the heat-deprived air to the outdoors as cold air CA by the fan 115.

When the air conditioner 1 is in the cooling operation, the outdoor heat exchanger 112 causes the outdoor air to absorb the heat of the high-temperature, high-pressure, and gaseous-state heat medium of the present invention, and releases the heat-deprived air to the outdoors as warm air WA by the fan 115.

Further, the indoor unit 12 also has an indoor heat exchanger 121.

Further, the indoor heat exchanger 121 has a fan 122.

Here, the indoor heat exchanger 121 forms a flow of fluid in a fixed direction by the fan 122. More specifically, the indoor heat exchanger 121 takes room air into the indoor heat exchanger 121 by the fan 122, transfers heat between the taken room air and the heat medium of the present invention, and then releases the air to the room as warm air WA or cold air CA by the fan 122.

When the air conditioner 1 is in the heating operation, the indoor heat exchanger 121 causes the room air to absorb the heat of the high-temperature, high-pressure, and gaseous-state heat medium of the present invention, and releases the heat-deprived air to the room as warm air WA by the fan 122.

When the air conditioner 1 is in the cooling operation, the indoor heat exchanger 121 causes the low-temperature, low-pressure, and liquid-state heat medium of the present invention to absorb the heat of the room air, and releases the heat-deprived air to the room as cold air CA by the fan 122.

Further, the outdoor unit 11 has a four-way selector valve 113.

Here, the four-way selector valve 113 communicates with the compressor 111, the outdoor heat exchanger 112, and the indoor heat exchanger 121 by piping, and switches the flow of the heat medium of the present invention sent from the compressor 111 through the piping.

More specifically, the four-way selector valve 113 forms a flow for sending the high-temperature and high-pressure heat medium of the present invention sent from the compressor 111 to the indoor heat exchanger 121 during the heating operation, and forms a flow for sending it to the outdoor heat exchanger 112 during the cooling operation.

Further, the outdoor unit 11 has an expansion valve 114.

Here, the expansion valve 114 communicates with the outdoor heat exchanger 112 and the indoor heat exchanger 121 by piping, and switches the flow of the heat medium of the present invention.

More specifically, the expansion valve 114 forms a flow for sending the heat medium of the present invention from the indoor heat exchanger 121 to the outdoor heat exchanger 112 during the heating operation, and forms a flow for sending the heat medium of the present invention from the outdoor heat exchanger 112 to the indoor heat exchanger 121 during the cooling operation.

Further, the outdoor unit 11 and the indoor unit 12 communicate with each other by the piping (101, 102), and more specifically, the four-way selector valve 113 of the outdoor unit 11 communicates with the indoor heat exchanger 121 of the indoor unit 12 by the piping 101 and the expansion valve 114 of the outdoor unit 11 communicates with the indoor heat exchanger 121 of the indoor unit 12 by the piping 102.

Further, arrows shown along the piping indicate the flow of the heat medium of the present invention in (a) of FIG. 1 and (b) of FIG. 1.

### Performance Evaluation Test

The refrigerant of the present invention (hereinafter, referred to as “HY-22”), R-22, which is a conventional refrigerant, and a conventional mixed refrigerant (hereinafter, referred to as “HY-99”) were each subjected to a performance evaluation test.

More specifically, these refrigerants were each used in the following air conditioner to perform a heating operation and a cooling operation.
Name of Equipment: TOSHIBA Room Air Conditioner R-22 Dedicated Machine
Outdoor Unit: RAS-225YAV
Indoor Unit: RAS-225YV
Single Phase, Output: 100V

Here, HY-22, which is the refrigerant of the present invention, contains 20% by mass of liquefied isobutane, 70% by mass of liquefied carbon dioxide, and 10% by mass of liquid nitrogen of the total amount of the refrigerant.

Here, the refrigerant is an example of the heat medium.

Further, HY-99, which is a conventional mixed refrigerant, contains 70% by mass of liquefied HFO-1234ze-1,3,3,3-tetrafluoroprop-1-ene, 20% by mass of liquefied carbon dioxide, and 10% by mass of liquid nitrogen of the total amount of the refrigerant.

The performance evaluation test was specifically performed as follows.

The refrigerant to be evaluated was sealed in the air conditioner, and the cooling operation and the heating operation were performed to measure various temperatures every 5 minutes from the start of the operation.

More specifically, an “outside air temperature,” which is the temperature of the outdoor air, a “room temperature,” which is the temperature of the room air, an “air outlet temperature,” which is the temperature of the air at the air outlet of the air conditioner, and an “air inlet temperature,” which is the temperature of the air at the air inlet of the air conditioner were each measured.

Further, a “difference,” which is a temperature difference between the “air inlet temperature” and the “air outlet temperature” was calculated.

Further, a value of “low pressure,” which is the pressure of the refrigerant used in the air conditioner when the refrigerant is in the liquid state, and a value of “high pressure,” which is the pressure of the refrigerant used in the air conditioner when the refrigerant is in the gaseous state, were measured every 5 minutes from the start of the operation.

Furthermore, the power consumption of the air conditioner was measured every 5 minutes from the start of the operation.

The structure and operation of the air conditioner used in the performance evaluation test are the same as those of the air conditioner 1 shown in FIG. 1.

### Performance Evaluation Result During Cooling Operation

Table 1 shows the results obtained by sealing HY-22 in the air conditioner, performing a cooling operation, and carrying out the above various measurements. Note that specific contents of the cooling operation of the air conditioner using HY-22 are that a first cooling operation for 25 minutes was performed and then the operation was stopped for about 10 minutes, and after that, a second cooling operation for 20 minutes was performed.

TABLE 1

| | Time | Outside air temp | Room temp | Air outlet temp | Air inlet temp | Low pressure | High pressure | Power (W) | Difference |
|---|---|---|---|---|---|---|---|---|---|
| 1 | 15:41 | 25.8 | 35.0 | 32.9 | 38.5 | 0.25 | 0.38 | 521 | - |
| | 15:46 | 29.2 | 24.0 | 11.9 | 24.6 | 0.22 | 0.37 | 524 | 12.7 |
| | 15:51 | 30.1 | 20.2 | 9.6 | 21.9 | 0.21 | 0.36 | 525 | 12.3 |
| | 15:56 | 30.6 | 18.2 | 8.5 | 19.9 | 0.20 | 0.35 | 526 | 11.4 |
| | 16:01 | 31.0 | 16.9 | 7.9 | 18.2 | 0.20 | 0.33 | 525 | 10.3 |
| | 16:06 | 31.4 | 15.8 | 7.0 | 17.2 | 0.20 | 0.33 | 522 | 10.2 |
| 2 | 16:15 | 28.2 | 34.4 | 16.8 | 24.3 | 0.20 | 0.35 | 506 | - |
| | 16:20 | 31.1 | 20.9 | 9.9 | 21.6 | 0.21 | 0.36 | 513 | 11.7 |
| | 16:25 | 32.2 | 17.3 | 8.3 | 19.2 | 0.20 | 0.35 | 512 | 10.9 |
| | 16:30 | 32.9 | 15.8 | 7.5 | 17.5 | 0.20 | 0.34 | 510 | 10.0 |
| | 16:35 | 33.3 | 15.1 | 7.0 | 17.1 | 0.20 | 0.34 | 510 | 10.1 |

In the table, the unit for various temperatures is “°C,” and the unit of pressure is “MPaG.”

Further, (a) of FIG. 2 is a graph showing changes over time for various temperatures for the first time when the cooling operation of the air conditioner was performed using the refrigerant to which the present invention was applied, and (b) of FIG. 2 is a graph showing changes over time for various temperatures for the second time when the cooling operation of the air conditioner was performed using the refrigerant to which the present invention was applied.

More specifically, (a) of FIG. 2 and (b) of FIG. 2 show an outside air temperature during the cooling operation using HY-22 CA1, a room temperature during the cooling operation using HY-22 CA2, an air outlet temperature during the cooling operation using HY-22 CA3, and an air inlet temperature during the cooling operation using HY-22 CA4.

Further, Table 2 shows the results obtained by sealing R-22 in the air conditioner, performing a cooling operation for 50 minutes, and carrying out the above various measurements.

TABLE 2

| | Time | Outside air temp | Room temp | Air outlet temp | Air inlet temp | Low pressure | High pressure | Power (W) | Difference |
|---|---|---|---|---|---|---|---|---|---|
| 1 | 12:22 | 28.8 | 39.6 | 30.8 | 39.2 | 0.79 | 0.82 | - | 8.4 |
| | 12:27 | 32.1 | 28.1 | 16.8 | 29.2 | 0.52 | 0.65 | 680 | 12.4 |
| | 12:32 | 33.4 | 23.8 | 12.7 | 25.6 | 0.42 | 0.63 | 980 | 12.9 |
| | 12:37 | 32.6 | 21.0 | 11.2 | 22.9 | 0.41 | 0.62 | 1001 | 11.7 |
| | 12:42 | 33.2 | 19.4 | 10.3 | 21.4 | 0.40 | 0.60 | 985 | 11.1 |
| | 12:47 | 32.9 | 18.0 | 9.3 | 19.8 | 0.40 | 0.60 | 981 | 10.5 |
| | 12:52 | 33.3 | 16.9 | 8.4 | 18.9 | 0.39 | 0.60 | 973 | 10.5 |
| | 12:57 | 33.4 | 16.4 | 8.8 | 18.1 | 0.45 | 0.60 | 780 | 9.3 |
| | 13:02 | 33.0 | 16.0 | 8.8 | 17.8 | 0.43 | 0.59 | 711 | 9.0 |
| | 13:07 | 33.3 | 15.6 | 8.8 | 17.8 | 0.45 | 0.60 | 657 | 9.0 |
| | 13:12 | 33.1 | 16.6 | 11.5 | 17.5 | 0.45 | 0.60 | 390 | 6.0 |

In the table, the unit for various temperatures is “°C,” and the unit of pressure is “MPaG.”

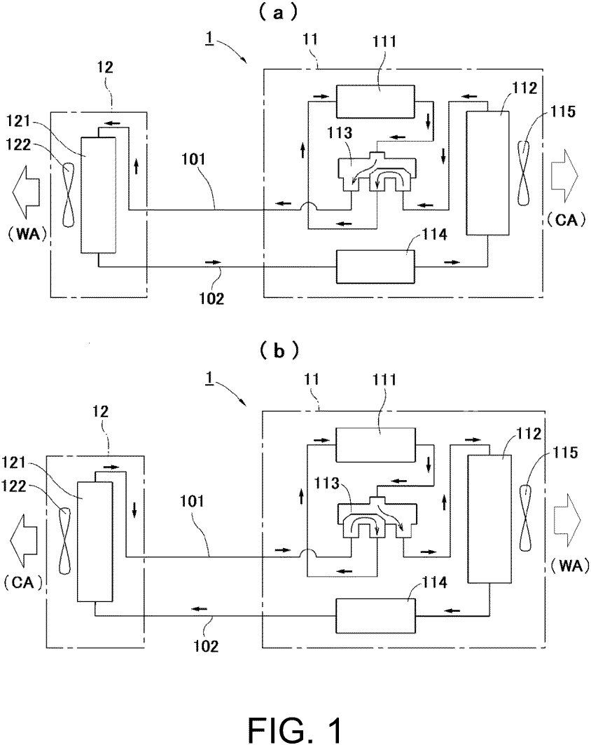

Further, FIG. 3 is a graph showing changes over time for various temperatures when the cooling operation of the air conditioner was performed using a conventional refrigerant R-22.

More specifically, FIG. 3 shows an outside air temperature during the cooling operation using R-22 CB1, a room temperature during the cooling operation using R-22 CB2, an air outlet temperature during the cooling operation using R-22 CB3, and an air inlet temperature during the cooling operation using R-22 CB4.

Further, Table 3 shows the results obtained by sealing HY-99 in the air conditioner, performing a cooling operation for 45 minutes, and carrying out the above various measurements.

TABLE 3

| | Time | Outside air temp | Room temp | Air outlet temp | Air inlet temp | Low pressure | High pressure | Power (W) | Difference |
|---|---|---|---|---|---|---|---|---|---|
| 1 | 9:05 | 28.9 | 38.5 | 35.7 | 38.7 | 0.55 | 0.60 | - | 3.0 |
| | 9:10 | 32.2 | 25.2 | 15.5 | 28.9 | 0.31 | 0.48 | 704 | 13.4 |
| | 9:15 | 34.2 | 21.4 | 13.1 | 25.0 | 0.31 | 0.49 | 714 | 11.9 |
| | 9:20 | 33.4 | 20.3 | 12.3 | 23.8 | 0.30 | 0.48 | 707 | 11.5 |
| | 9:25 | 34.5 | 18.4 | 11.2 | 22.2 | 0.30 | 0.45 | 709 | 11.0 |
| | 9:30 | 33.7 | 16.0 | 9.9 | 20.8 | 0.30 | 0.45 | 701 | 10.9 |
| | 9:35 | 34.0 | 15.0 | 9.3 | 19.6 | 0.30 | 0.43 | 701 | 10.3 |
| | 9:40 | 33.4 | 17.4 | 10.3 | 19.7 | 0.32 | 0.43 | 531 | 9.4 |
| | 9:45 | 33.4 | 16.4 | 9.8 | 18.8 | 0.32 | 0.44 | 496 | 9.0 |
| | 9:50 | 33.0 | 17.5 | 10.3 | 18.8 | 0.36 | 0.45 | 377 | 8.5 |

In the table, the unit for various temperatures is “°C,” and the unit of pressure is “MPaG.”

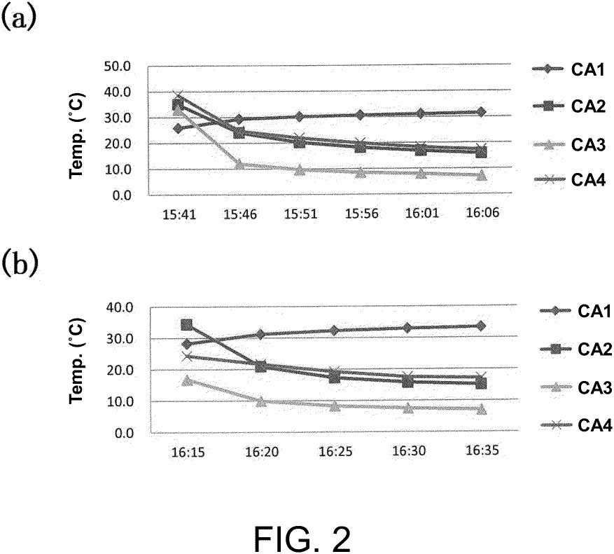

Further, FIG. 4 is a graph showing changes over time for various temperatures when the cooling operation of the air conditioner was performed using a conventional refrigerant HY-99.

More specifically, FIG. 4 shows an outside air temperature during the cooling operation using HY-99 CC1, a room temperature during the cooling operation using HY-99 CC2, an air outlet temperature during the cooling operation using HY-99 CC3, and an air inlet temperature during the cooling operation using HY-99 CC4.

As can be seen from Table 1 to Table 3, the value of the temperature difference between the air inlet temperature and the air outlet temperature at the time of cooling operation using HY-22, which is the refrigerant of the present invention, was always two digits except at the start of the first operation and at the start of the second operation, whereas the value of the temperature difference between the air inlet temperature and the air outlet temperature at the time of cooling operation using R-22, which is a conventional refrigerant, and the value of the temperature difference between the air inlet temperature and the air outlet temperature at the time of cooling operation using HY-99, which is a conventional refrigerant, became 1 digit from about 10 minutes before the end of the operation.

From this, it can be seen that HY-22 can exhibit heat transfer performance equal to or greater than R-22 and HY-99 in the cooling operation of the air conditioner.

Further, as can be seen from Table 1 to Table 3, the value of “high pressure” at the time of cooling operation using HY-22 showed a value lower than the value of “high pressure” at the time of cooling operation using R-22 and the value of “high pressure” at the time of cooling operation using HY-99.

Further, the value of “low pressure” at the time of cooling operation using HY-22 also showed a value lower than the value of “low pressure” at the time of cooling operation using R-22 and the value of “low pressure” at the time of cooling operation using HY-99.

From these results, it was confirmed that the use of the refrigerant of the present invention can cause the air conditioner to perform the cooling operation at a pressure lower than in the case of using the conventional refrigerants, and can reduce the load on the compressor to reduce the power consumption.

### Performance Evaluation Result During Heating Operation

Table 4 shows the results obtained by sealing HY-22 in the air conditioner, performing a heating operation for 35 minutes, and carrying out the above various measurements.

TABLE 4

| | Time | Outside air temp | Room temp | Air outlet temp | Air inlet temp | Low pressure | High pressure | Power (W) | Difference |
|---|---|---|---|---|---|---|---|---|---|
| 1 | 11:22 | 14.4 | 14.0 | 23.6 | 19.5 | 1.10 | 1.13 | 566 | - |
| | 11:27 | 13.0 | 25.5 | 45.5 | 28.1 | 1.30 | 1.35 | 642 | 17.4 |
| | 11:32 | 13.6 | 27.1 | 40.1 | 28.8 | 1.28 | 1.34 | 629 | 11.3 |
| | 11:37 | 12.6 | 28.0 | 43.5 | 29.8 | 1.29 | 1.33 | 630 | 13.7 |
| | 11:42 | 13.9 | 28.1 | 41.9 | 30.9 | 1.11 | 1.19 | 535 | 11.0 |
| | 11:47 | 13.3 | 28.5 | 43.6 | 31.2 | 1.15 | 1.20 | 538 | 12.4 |
| | 11:52 | 13.3 | 28.6 | 41.0 | 31.2 | 1.20 | 1.28 | 596 | 9.8 |
| | 11:57 | 13.3 | 28.8 | 44.8 | 31.3 | 1.20 | 1.21 | 524 | 13.5 |

In the table, the unit for various temperatures is “°C,” and the unit of pressure is “MPaG.”

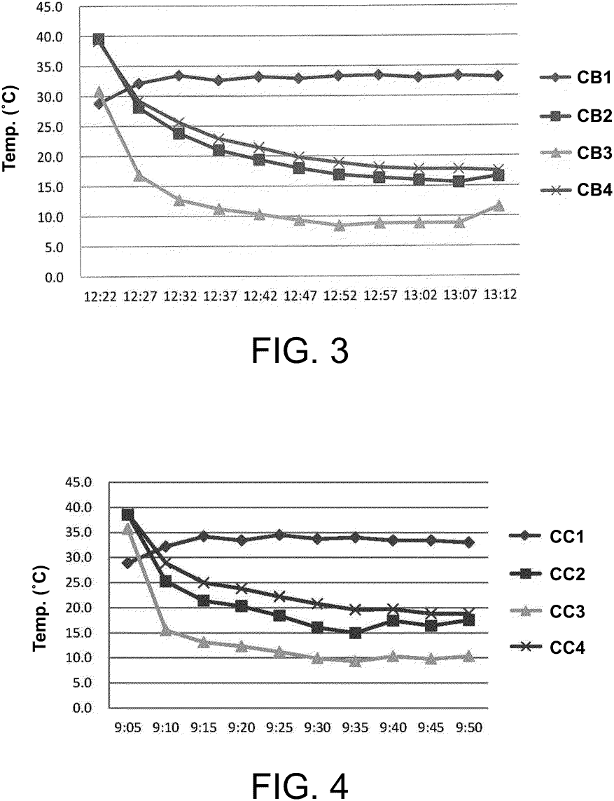

Further, FIG. 5 is a graph showing changes over time for various temperatures when the heating operation of the air conditioner was performed using the refrigerant to which the present invention was applied.

More specifically, FIG. 5 shows an outside air temperature during the heating operation using HY-22 WA1, a room temperature during the heating operation using HY-22 WA2, an air outlet temperature during the heating operation using HY-22 WA3, and an air inlet temperature during the heating operation using HY-22 WA4.

Further, Table 5 shows the results obtained by sealing R-22 in the air conditioner, performing a heating operation for 20 minutes, and carrying out the above various measurements.

TABLE 5

| | Time | Outside air temp | Room temp | Air outlet temp | Air inlet temp | Low pressure | High pressure | Power (W) | Difference |
|---|---|---|---|---|---|---|---|---|---|
| 1 | 4:45 | 18.8 | 22.1 | 21.0 | 20.5 | 0.95 | 0.95 | 745 | 0.5 |
| | 4:50 | 18.1 | 22.6 | 29.9 | 23.1 | 1.56 | 1.56 | 749 | 6.8 |
| | 4:55 | 18.1 | 27.7 | 44.3 | 30.2 | 2.22 | 2.22 | 1092 | 14.1 |
| | 5:00 | 18.0 | 31.9 | 51.9 | 34.7 | 2.48 | 2.45 | 683 | 17.2 |
| | 5:05 | 18.2 | 32.5 | 48.5 | 34.5 | 2.19 | 2.20 | 455 | 14.0 |

In the table, the unit for various temperatures is “°C,” and the unit of pressure is “MPaG.”

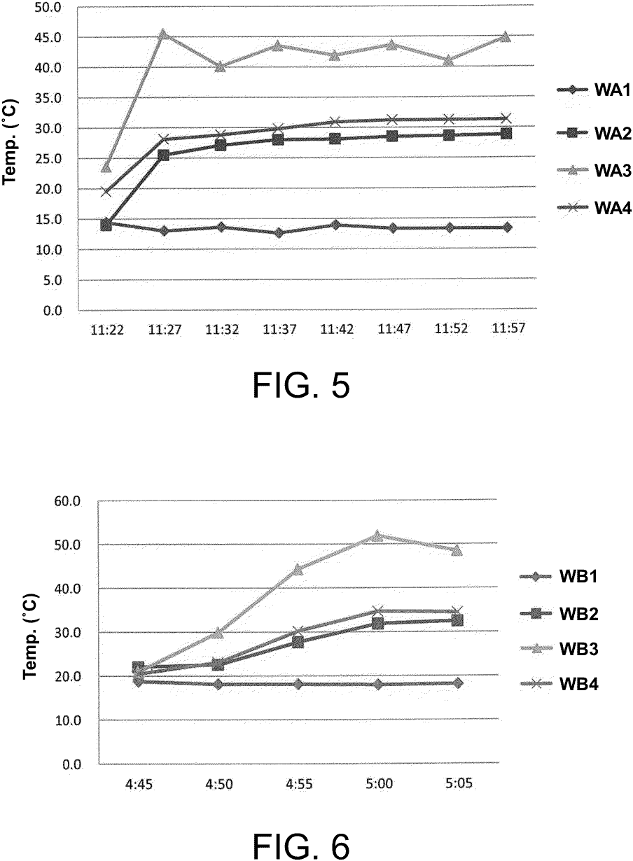

Further, FIG. 6 is a graph showing changes over time for various temperatures when the heating operation of the air conditioner was performed using the conventional refrigerant R-22.

More specifically, FIG. 6 shows an outside air temperature during the heating operation using R-22 WB1, a room temperature during the heating operation using R-22 WB2, an air outlet temperature during the heating operation using R-22 WB3, and an air inlet temperature during the heating operation using R-22 WB4.

Further, Table 6 shows the results obtained by sealing HY-99 in the air conditioner, performing a heating operation for 55 minutes, and carrying out the above various measurements.

TABLE 6

| | Time | Outside air temp | Room temp | Air outlet temp | Air inlet temp | Low pressure | High pressure | Power (W) | Difference |
|---|---|---|---|---|---|---|---|---|---|
| 1 | 6:05 | 14.7 | 19.9 | 20.2 | 20.1 | 1.30 | 1.70 | - | 0.1 |
| | 6:15 | 13.5 | 21.3 | 31.6 | 22.2 | 1.50 | 1.50 | 819 | 9.4 |
| | 6:20 | 13.4 | 27.2 | 46.2 | 29.4 | 1.82 | 1.85 | 818 | 16.8 |
| | 6:25 | 13.5 | 29.6 | 50.2 | 32.1 | 1.84 | 1.90 | 677 | 18.1 |
| | 6:30 | 14.4 | 30.8 | 48.8 | 33.5 | 1.81 | 1.85 | 605 | 15.3 |
| | 6:35 | 13.5 | 31.6 | 47.0 | 35.5 | 1.79 | 1.80 | 565 | 11.5 |
| | 6:40 | 14.2 | 31.5 | 44.5 | 33.3 | 1.61 | 1.66 | 402 | 11.2 |
| | 6:45 | 14.9 | 30.7 | 41.9 | 32.2 | 1.56 | 1.60 | 415 | 9.7 |
| | 6:50 | 13.4 | 31.3 | 42.6 | 32.8 | 1.59 | 1.60 | 414 | 9.8 |
| | 6:55 | 13.7 | 31.6 | 42.1 | 32.8 | 1.51 | 1.57 | 364 | 9.3 |
| | 7:00 | 14.0 | 31.4 | 40.8 | 32.2 | 1.50 | 1.52 | 364 | 8.6 |

In the table, the unit for various temperatures is “°C,” and the unit of pressure is “MPaG.”

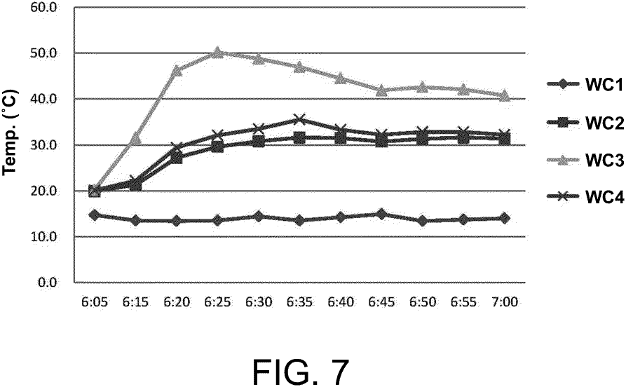

Further, FIG. 7 is a graph showing changes over time for various temperatures when the heating operation of the air conditioner was performed using the conventional refrigerant HY-99.

More specifically, FIG. 7 shows an outside air temperature during the heating operation using HY-99 WC1, a room temperature during the heating operation using HY-99 WC2, an air outlet temperature during the heating operation using HY-99 WC3, and an air inlet temperature during the heating operation using HY-99 WC4.

As can be seen from Table 4 to Table 6, the value of the temperature difference between the air inlet temperature and the air outlet temperature at the time of heating operation using HY-22 was two digits except at the start of the operation and when 30 minutes have passed since the start of the operation, whereas the value of the temperature difference between the air inlet temperature and the air outlet temperature at the time of heating operation using R-22 was 1 digit at the start of the operation and when 5 minutes have passed since the start of the operation, and the value of the temperature difference between the air inlet temperature and the air outlet temperature at the time of heating operation using HY-99 was 1 digit except from when 15 minutes have passed since the start of the operation to when 35 minutes have passed.

From this, it can be seen that HY-22 can exhibit heat transfer performance equal to or greater than R-22 and HY-99 in the heating operation of the air conditioner.

Further, as can be seen from Table 4 to Table 6, the value of “high pressure” at the time of heating operation using HY-22 showed a value lower than the value of “high pressure” at the time of heating operation using R-22 except at the start of the operation, and showed a value lower than the value of “high pressure” at the time of heating operation using HY-99.

Further, the value of “low pressure” at the time of heating operation using HY-22 also showed a value lower than the value of “low pressure” at the time of heating operation using R-22 except at the start of the operation, and showed a value lower than the value of “low pressure” at the time of heating operation using HY-99.

From these results, it was confirmed that the use of the refrigerant of the present invention can cause the air conditioner to perform the heating operation at a pressure lower than in the case of using the conventional refrigerants, and can reduce the load on the compressor to reduce the power consumption.

Further, the heat medium of the present invention is not always required to contain liquid nitrogen. However, if it contains liquid nitrogen, it is preferable because non-flammability is further increased and cooling capacity is enhanced.

Further, the content of liquefied isobutane, the content of liquefied carbon dioxide, and the content of liquid nitrogen in the heat medium of the present invention used in the performance evaluation test are examples, and it is a matter of course that the contents are not limited to these contents.

As described above, the refrigerant, or the heat medium, of the present invention is one in which flammable liquefied isobutane is mixed with non-flammable liquefied carbon dioxide, so that the heat medium of the present invention can be non-flammable even when containing isobutane.

Further, the heat medium of the present invention contains liquefied carbon dioxide, so that high cooling capacity can be exhibited.

Further, the heat medium of the present invention containing liquefied isobutane and liquefied carbon dioxide does not contain chlorine or fluorine, so that the ozone depletion potential is “0” and the global warming potential is “1 or less.”

Accordingly, as obvious from the results of the performance evaluation test, the heat medium of the present invention exhibits sufficient heat transfer performance, has a low environmental load, and is non-flammable.

DESCRIPTION OF REFERENCE NUMERALS

| | |
|---|---|
| 1 | Air conditioner |
| 101 | Piping |
| 102 | Piping |
| 11 | Outdoor unit |
| 111 | Compressor |
| 112 | Outdoor heat exchanger |
| 113 | Four-way selector valve |
| 114 | Expansion valve |
| 115 | Fan |
| 12 | Indoor unit |
| 121 | Indoor heat exchanger |
| 122 | Fan |
| CA | Cold air |
| WA | Warm air |
| CA1 | Outside air temperature during the cooling operation using HY-22 |
| CA2 | Room temperature during the cooling operation using HY-22 |
| CA3 | Air outlet temperature during the cooling operation using HY-22 |
| CA4 | Air inlet temperature during the cooling operation using HY-22 |
| CB1 | Outside air temperature during the cooling operation using R-22 |
| CB2 | Room temperature during the cooling operation using R-22 |
| CB3 | Air outlet temperature during the cooling operation using R-22 |
| CB4 | Air inlet temperature during the cooling operation using R-22 |
| CC1 | Outside air temperature during the cooling operation using HY-99 |
| CC2 | Room temperature during the cooling operation using HY-99 |
| CC3 | Air outlet temperature during the cooling operation using HY-99 |
| CC4 | Air inlet temperature during the cooling operation using HY-99 |
| WA1 | Outside air temperature during the heating operation using HY-22 |
| WA2 | Room temperature during the heating operation using HY-22 |
| WA3 | Air outlet temperature during the heating operation using HY-22 |
| WA4 | Air inlet temperature during the heating operation using HY-22 |
| WB1 | Outside air temperature during the heating operation using R-22 |
| WB2 | Room temperature during the heating operation using R-22 |
| WB3 | Air outlet temperature during the heating operation using R-22 |
| WB4 | Air inlet temperature during the heating operation using R-22 |
| WC1 | Outside air temperature during the heating operation using HY-99 |
| WC2 | Room temperature during the heating operation using HY-99 |
| WC3 | Air outlet temperature during the heating operation using HY-99 |
| WC4 | Air inlet temperature during the heating operation using HY-99 |

What is claimed is:

1. A heat medium comprising:
liquefied isobutane; and
liquefied carbon dioxide.

2. The heat medium according to claim 1, further comprising liquid nitrogen.

3. The heat medium according to claim 2, wherein
the liquefied isobutane has a content of 20 to 30% by mass of a total amount of the heat medium,
the liquefied carbon dioxide has a content of 50 to 70% by mass of the total amount of the heat medium, and
the liquid nitrogen has a content of 10 to 20% by mass of the total amount of the heat medium.

4. The heat medium according to claim 2, wherein
the liquefied isobutane has a content of 20% by mass of a total amount of the heat medium,
the liquefied carbon dioxide has a content of 70% by mass of the total amount of the heat medium, and
the liquid nitrogen has a content of 10% by mass of the total amount of the heat medium.

5. The heat medium according to claim 1, further comprising benzotriazole.

6. The heat medium according to claim 2, further comprising benzotriazole.

7. The heat medium according to claim 6, wherein
the liquefied isobutane has a content of 20 to 30% by mass of a total amount of the heat medium,
the liquefied carbon dioxide has a content of 30 to 50% by mass of the total amount of the heat medium,
the liquid nitrogen has a content of 15 to 25% by mass of the total amount of the heat medium, and
the benzotriazole has a content of 1 to 10% by mass of the total amount of the heat medium.

8. The heat medium according to claim 7, wherein
the liquefied isobutane has a content of 29% by mass of a total amount of the heat medium,
the liquefied carbon dioxide has a content of 49% by mass of the total amount of the heat medium,
the liquid nitrogen has a content of 19% by mass of the total amount of the heat medium, and
the benzotriazole has a content of 3% by mass of the total amount of the heat medium.
